(19) United States
(12) Patent Application Publication
(10) Pub. No.: US 2015/0312366 A1
(43) Pub. Date: Oct. 29, 2015

(54) UNIFIED CACHING OF STORAGE BLOCKS AND MEMORY PAGES IN A COMPUTE-NODE CLUSTER

(71) Applicant: Strato Scale Ltd., Herzlia (IL)

(72) Inventors: Muli Ben-Yehuda, Haifa (IL); Shlomo Matichin, Petach Tikva (IL); Ariel Maislos, Bnei Tzion (IL); Etay Bogner, Tel Aviv (IL)

(73) Assignee: Strato Scale Ltd., Herzlia (IL)

(21) Appl. No.: 14/260,304

(22) Filed: Apr. 24, 2014

(51) Int. Cl. H04L 29/08

(52) U.S. Cl. CPC H04L 67/2842; H04L 67/10

(57) ABSTRACT

A method includes, in a plurality of compute nodes that communicate with one another over a communication network, running one or more Virtual Machines (VMs) that access storage blocks stored on non-volatile storage devices coupled to at least some of the compute nodes. One or more of the storage blocks accessed by a given VM, which runs on a first compute node, are cached in a volatile memory of a second compute node that is different from the first compute node. The cached storage blocks are served to the given VM.

### FIELD OF THE INVENTION

The present invention relates generally to computing systems, and particularly to methods and systems for resource sharing among compute nodes.

### BACKGROUND OF THE INVENTION

Machine virtualization is commonly used in various computing environments, such as in data centers and cloud computing. Various virtualization solutions are known in the art. For example, VMware, Inc. (Palo Alto, Calif.), offers virtualization software for environments such as data centers, cloud computing, personal desktop and mobile computing.

U.S. Pat. No. 8,266,238, whose disclosure is incorporated herein by reference, describes an apparatus including a physical memory configured to store data and a chipset configured to support a virtual machine monitor (VMM). The VMM is configured to map virtual memory addresses within a region of a virtual memory address space of a virtual machine to network addresses, to trap a memory read or write access made by a guest operating system, to determine that the memory read or write access occurs for a memory address that is greater than the range of physical memory addresses available on the physical memory of the apparatus, and to forward a data read or write request corresponding to the memory read or write access to a network device associated with the one of the plurality of network addresses corresponding to the one of the plurality of the virtual memory addresses.

U.S. Pat. No. 8,082,400, whose disclosure is incorporated herein by reference, describes firmware for sharing a memory pool that includes at least one physical memory in at least one of plural computing nodes of a system. The firmware partitions the memory pool into memory spaces allocated to corresponding ones of at least some of the computing nodes, and maps portions of the at least one physical memory to the memory spaces. At least one of the memory spaces includes a physical memory portion from another one of the computing nodes.

U.S. Pat. No. 8,544,004, whose disclosure is incorporated herein by reference, describes a cluster-based operating system-agnostic virtual computing system. In an embodiment, a cluster-based collection of nodes is realized using conventional computer hardware. Software is provided that enables at least one VM to be presented to guest operating systems, wherein each node participating with the virtual machine has its own emulator or VMM. VM memory coherency and I/O coherency are provided by hooks, which result in the manipulation of internal processor structures. A private network provides communication among the nodes.

### SUMMARY OF THE INVENTION

An embodiment of the present invention that are described herein provides a method including, in a plurality of compute nodes that communicate with one another over a communication network, running one or more Virtual Machines (VMs) that access storage blocks stored on non-volatile storage devices coupled to at least some of the compute nodes. One or more of the storage blocks accessed by a given VM, which runs on a first compute node, are cached in a volatile memory of a second compute node that is different from the first compute node. The cached storage blocks are served to the given VM.

In some embodiments, caching the storage blocks includes caching the storage blocks accessed by the given VM in respective volatile memories of at least two of the compute nodes. In some embodiments, the VMs further access memory pages stored in respective volatile memories of the compute nodes, and the method includes, upon identifying a cached storage block and a memory page that are stored on the same compute node and hold respective copies of the same content, discarding the cached storage block or the memory page. In an embodiment, the VMs further access memory pages stored in respective volatile memories of the compute nodes, and serving the cached storage blocks includes responding to a request from the given VM for a storage block by retrieving a memory page having identical content to the requested storage block, and serving the retrieved memory page to the VM in place of the requested storage block.

In some embodiments, caching and serving the storage blocks include running on the compute nodes respective memory sharing agents that communicate with one another over the communication network, and caching and serving the storage blocks using the memory sharing agents. In an example embodiment, the method includes caching a given storage block by defining one of the memory sharing agents as owning the given storage block, and caching the given storage block using the one of the memory sharing agents.

In some embodiments, serving the cached storage blocks includes, in response to recognizing that a storage block requested by the given VM is not cached on the first compute node, fetching the requested storage block using the memory sharing agents. In an embodiment, fetching the requested storage block includes sending a query, from a first memory sharing agent of the first compute node to a second memory sharing agent of one of the compute nodes that is defined as owning the requested storage block, for an identity of a third compute node on which the requested storage block is stored, and requesting the storage block from the third compute node.

In another embodiment, fetching the requested storage block includes identifying the requested storage block to the memory sharing agents by an identifier indicative of a storage location of the requested storage block in the non-volatile storage devices. In an alternative embodiment, fetching the requested storage block includes identifying the requested storage block to the memory sharing agents by an identifier indicative of a content of the requested storage block.

There is additionally provided, in accordance with an embodiment of the present invention, a system including a plurality of compute nodes that include respective volatile memories and respective processors. The processors are configured to run one or more Virtual Machines (VMs) that access storage blocks stored on non-volatile storage devices coupled to at least some of the compute nodes, to cache one or more of the storage blocks accessed by a given VM, which runs on a first compute node, in a volatile memory of a second compute node that is different from the first compute node, and to serve the cached storage blocks to the given VM.

There is also provided, in accordance with an embodiment of the present invention, a compute node including a volatile memory and a processor. The processor is configured to run, in conjunction with respective processors of other compute nodes that communicate with one another over a communication network, one or more Virtual Machines (VMs) that access storage blocks stored on non-volatile storage devices coupled to at least some of the compute nodes, to cache one or more of the storage blocks accessed by a given VM, which runs on a first compute node, in a volatile memory of a second compute node that is different from the first compute node, and to serve the cached storage blocks to the given VM.

There is further provided, in accordance with an embodiment of the present invention, a computer software product, the product including a tangible non-transitory computer-readable medium in which program instructions are stored, which instructions, when read by a processor of a compute node that runs, in conjunction with respective processors of other compute nodes that communicate with one another over a communication network, one or more local Virtual Machines (VMs) that access storage blocks stored on non-volatile storage devices coupled to at least some of the compute nodes, cause the processor to cache one or more of the storage blocks accessed by a given VM, which runs on a first compute node, in a volatile memory of a second compute node that is different from the first compute node, and to serve the cached storage blocks to the given VM.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a cluster of compute nodes, in accordance with an embodiment of the present invention;

FIG. 2 is a diagram that schematically illustrates a distributed architecture for unified memory page and storage block caching, in accordance with an embodiment of the present invention; and

FIGS. 3A-3E are flow diagrams that schematically illustrate message flows in a cluster of compute nodes that uses unified memory page and storage block caching, in accordance with embodiments of the present invention.

### DETAILED DESCRIPTION OF EMBODIMENTS

### Overview

Various computing systems, such as data centers, cloud computing systems and High-Performance Computing (HPC) systems, run Virtual Machines (VMs) over a cluster of compute nodes connected by a communication network. The VMs typically run applications that use both volatile memory resources (e.g., Random Access Memory—RAM) and non-volatile storage resources (e.g., Hard Disk Drives—HDDs or Solid State Drives—SSDs).

Embodiments of the present invention that are described herein provide methods and systems for cluster-wide sharing of volatile memory and non-volatile storage resources. In particular, the embodiments described herein provide a distributed cluster-wide caching mechanism, which caches storage blocks that are stored in non-volatile storage devices (e.g., HDDs or SSDs) of the various nodes.

The disclosed caching mechanism is distributed, in the sense that storage blocks accessed by a given VM may be cached in volatile memories of any number of nodes across the cluster. In some embodiments, the caching mechanism treats cached storage blocks and stored memory pages in a unified manner. For example, if a given cached storage block and a given memory page, both stored in the same node, are found to hold identical copies of the same content, one of these copies may be discarded to save memory. As another example, in response to VM requesting access to a storage block, the caching mechanism may serve a memory page having the same content as the requested storage block.

The distributed and unified structure of the disclosed caching scheme is typically transparent to the VMs: Each VM accesses memory pages and storage blocks as needed, and an underlying virtualization layer handles the cluster-wide caching, storage and memory management functions.

In some embodiments, each compute node in the cluster runs a respective memory sharing agent, referred to herein as a Distributed Page Store (DPS) agent. The DPS agents, referred to collectively as a DPS network, communicate with one another so as to carry out the disclosed caching techniques. Additional aspects of distributed memory management using DPS agents are addressed in U.S. patent application Ser. No. 14/181,791, entitled “Memory resource sharing among multiple compute nodes,” which is assigned to the assignee of the present patent application and whose disclosure is incorporated herein by reference.

The disclosed techniques are highly efficient in utilizing the volatile memory resources of the various compute nodes for caching of storage blocks. When using these techniques, VMs are provided with a considerably faster access time to non-volatile storage. Moreover, by unifying storage block caching and memory page storage, the effective memory size available to the VMs is increased. The performance gain of the disclosed techniques is particularly significant for large clusters that operate many VMs, but the methods and systems described herein can be used with any suitable cluster size or environment.

### System Description

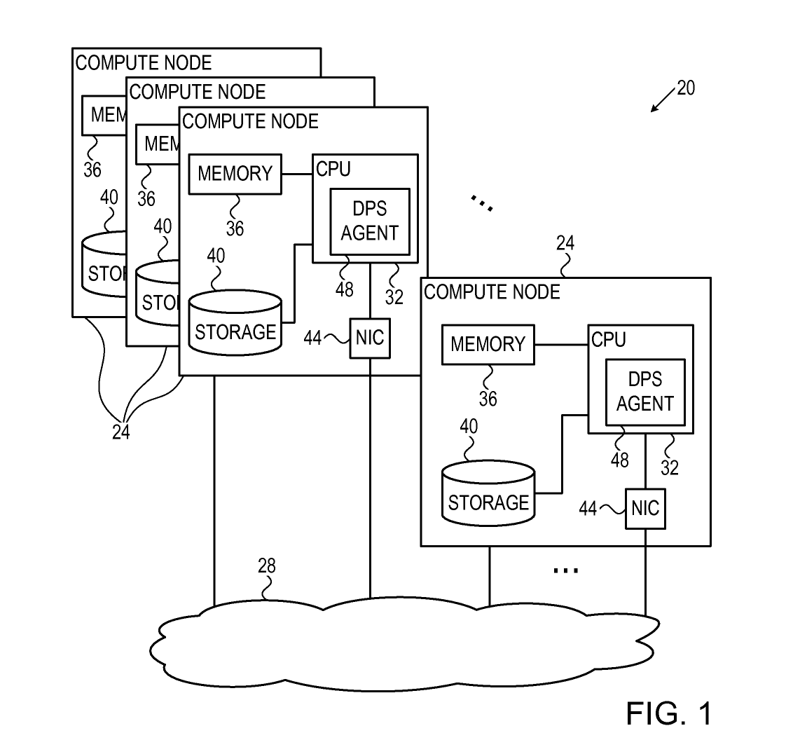

FIG. 1 is a block diagram that schematically illustrates a computing system 20, which comprises a cluster of multiple compute nodes 24, in accordance with an embodiment of the present invention. System 20 may comprise, for example, a data center, a cloud computing system, a High-Performance Computing (HPC) system or any other suitable system.

Compute nodes 24 (referred to simply as “nodes” for brevity) typically comprise servers, but may alternatively comprise any other suitable type of compute nodes. System 20 may comprise any suitable number of nodes, either of the same type or of different types. Nodes 24 are connected by a communication network 28, typically a Local Area Network (LAN). Network 28 may operate in accordance with any suitable network protocol, such as Ethernet or Infiniband.

Each node 24 comprises a Central Processing Unit (CPU) 32. Depending on the type of compute node, CPU 32 may comprise multiple processing cores and/or multiple Integrated Circuits (ICs). Regardless of the specific node configuration, the processing circuitry of the node as a whole is regarded herein as the node CPU. Each node 24 further comprises a volatile memory 36, typically a Random Access Memory (RAM) such as Dynamic RAM (DRAM), and a Network Interface Card (NIC) 44 for communicating with network 28. Some of nodes 24 (but not necessarily all nodes) comprise a non-volatile storage device 40 (e.g., a magnetic Hard Disk Drive—HDD—or Solid State Drive—SSD).

Nodes 24 typically run Virtual Machines (VMs) that in turn run customer applications. Typically, the VMs access (read and write) memory pages in volatile memories 36, as well as storage blocks in non-volatile storage devices 40. In some embodiments, CPUs 32 of nodes 24 cooperate with one another in accessing memory pages and storage blocks, and in caching storage blocks in volatile memory for fast access.

For the purpose of this cooperation, the CPU of each node runs a Distributed Page Store (DPS) agent 48. DPS agents 48 in the various nodes communicate with one another over network 28 for coordinating storage and caching of memory pages and storage blocks, as will be explained in detail below. The multiple DPS agents are collectively referred to herein as a “DPS network.” DPS agents 48 are also referred to as “DPS daemons,” “memory sharing daemons” or simply “agents” or “daemons.” All of these terms are used interchangeably herein.

The system and compute-node configurations shown in FIG. 1 are example configurations that are chosen purely for the sake of conceptual clarity. In alternative embodiments, any other suitable system and/or node configuration can be used. The various elements of system 20, and in particular the elements of nodes 24, may be implemented using hardware/firmware, such as in one or more Application-Specific Integrated Circuit (ASICs) or Field-Programmable Gate Array (FPGAs). Alternatively, some system or node elements, e.g., CPUs 32, may be implemented in software or using a combination of hardware/firmware and software elements. In some embodiments, CPUs 32 comprise general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Unified Distributed Caching of Memory Pages and Storage Blocks

The VMs running on nodes 24 typically use both the volatile resources (memories 36) and the non-volatile or persistent storage resources (storage devices 40) of the nodes. In the description that follows, data stored in volatile memories 36 is stored in units referred to as memory pages, and data stored in non-volatile storage devices 40 is stored in units referred to as storage blocks. The memory pages and storage blocks may generally be of the same size or of different sizes.

Since storage devices 40 have a considerably slower access time than memories 36, system 20 carries out a caching scheme that caches some of the storage blocks (usually the frequently-accessed blocks) in memories 36. In some cases, a storage block accessed by a given VM is cached in the memory of the same node that runs the VM. In other cases, however, a storage block accessed by a VM is cached in the memory of a different node. Accessing a remotely-cached storage block is still faster than accessing a storage block stored on a storage device 40, even when the storage device comprises an SSD. In some embodiments, the cluster-wide caching operations are carried out by the DPS network, i.e., collectively by DPS agents 48.

In addition to distributed caching, the DPS network also treats cached storage blocks and stored memory pages in a unified manner. For example, if a given cached storage block and a given memory page, both stored on the same node, are found to hold identical copies of the same content, one of these copies may be discarded. This de-duplication operation is typically confined to duplicate copies stored on the same node, and therefore have no impact on fault tolerance or redundant storage of pages and blocks on multiple nodes. As another example, in response to VM requesting access to a storage block, the caching mechanism may serve a memory page having the same content as the requested storage block.

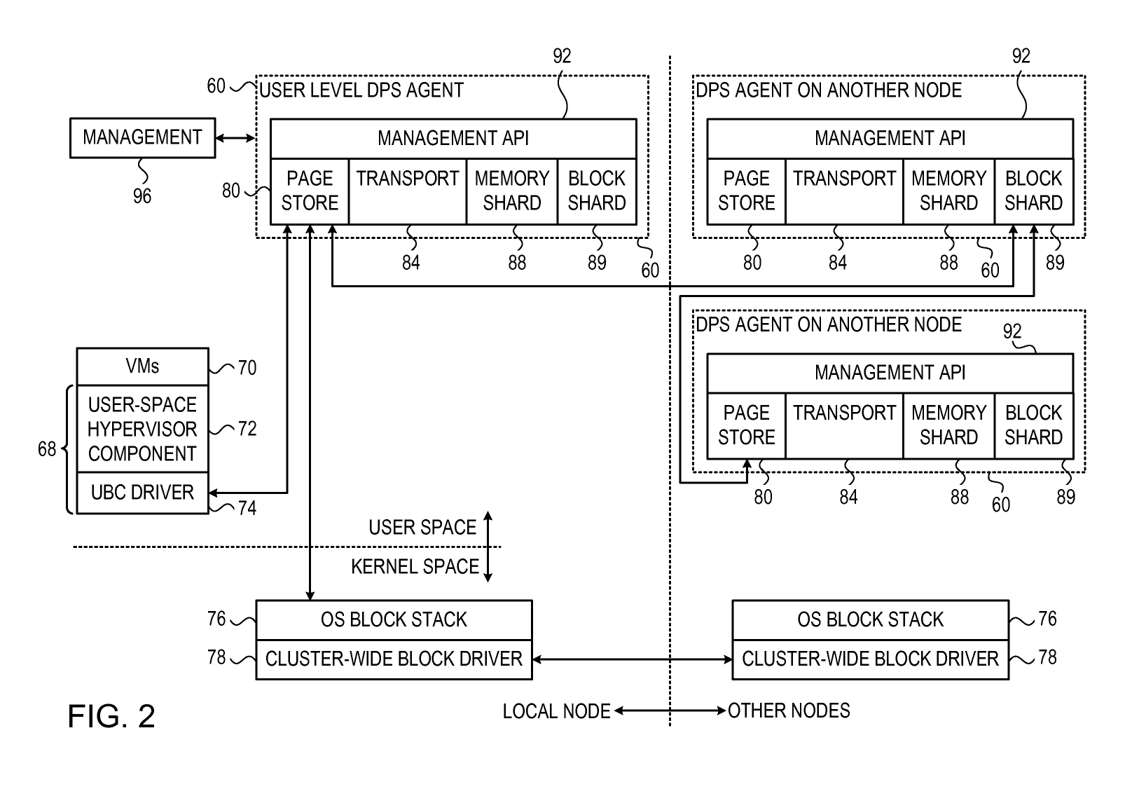

FIG. 2 is a diagram that schematically illustrates a distributed architecture for unified memory page and storage block caching, in accordance with an embodiment of the present invention. The left-hand-side of the figure shows the components running on the CPU of a given node 24, referred to as a local node. Each node 24 in system 20 is typically implemented in a similar manner. The right-hand-side of the figure shows components of other nodes that interact with the local node. In the local node (left-hand-side of the figure), the components are partitioned into a kernel space (bottom of the figure) and user space (top of the figure). The latter partitioning is mostly implementation-driven and not mandatory.

In the present example, each node runs a respective user-space DPS agent 60, similar in functionality to DPS agent 48 in FIG. 1 above. The node runs a hypervisor 68, whose functionality is partially implemented in a user-space hypervisor component 72. In the present embodiment the hypervisor comprises a Unified Block Cache (UBC) driver 74. In the present example, although not necessarily, the user-space hypervisor component is based on QEMU. Hypervisor 68 runs one or more VMs 70 and provides the VMs with resources such as memory, storage and CPU resources.

In this architecture, VMs do not access storage blocks directly, but rather via hypervisor 68. When a VM needs to access (read from or write to) a storage block, the VM requests hypervisor 68 to perform access the block. UBC driver 74 in the hypervisor communicates with the local DPS agent 60, so as to access the block either locally or remotely via the DPS network. The UBC driver typically maintains minimal state—All block state is typically maintained in the DPS network. Communication between the UBC driver and the local DPS agent is typically highly efficient in terms of latency and overhead. In an example embodiment, the UBC driver and the local DPS agent communicate using a shared memory ring for control information, and via a shared memory segment for data transfer. Alternatively, the UBC driver and the local DPS agent may communicate using any other suitable means.

DPS agent 60 comprises four major components—a page store 80, a transport layer 84, a memory shard component 88, and a block shard component 89. Page store holds the actual content (data) of the memory pages stored on the node, and of the storage blocks that are cached in the volatile memory of the node. Transport layer 84 is responsible for communicating and exchanging pages and storage blocks with peer transport layers 84 of other nodes. A management Application Programming Interface (API) 92 in DPS agent 60 communicates with a management layer 96.

Memory shard 88 holds metadata of memory pages. The metadata of a page may comprise, for example, the physical location of the page in the cluster, i.e., an indication of the node or nodes holding a copy of this page, and a hash value computed over the page content. The hash value of the page is used as a unique identifier that identifies the page (and its identical copies) cluster-wide. The hash value is also referred to as Global Unique Content ID (GUCID). Note that hashing is just an example form of signature or index that may be used for indexing the page content. Alternatively, any other suitable signature or indexing scheme can be used.

Block shard 89 holds metadata of cached storage blocks. The metadata of a cached storage block may comprise, for example, the storage location of the storage block in one of storage devices 40. In the embodiments described herein, the storage location of each cached storage block is identified by a unique pair of Logical Unit Number (LUN) and Logical Block Address (LBA). The LUN identifies the storage device 40 on which the block is stored, and the LBA identifies the logical address of the block within the address space of that storage device. The pair {LUN,LBA} thus forms a cluster-wide address space that spans the collection of storage devices 40. Other location identification or addressing schemes can also be used.

In some embodiments, in addition to location-based identification, some of the cached storage blocks may also be identified by content, e.g., using a hash value such as GUCID similarly to memory pages. The use of the two types of identifiers of storage blocks (by location and by content) is described in detail further below. In an example embodiment, the DPS network calculates a content identifier (e.g., GUCID) for a block upon recognizing that the block content does not change often and the block is not evicted often. Thus, content-based identifiers will often be calculated for storage blocks that are primarily read-only. Content-based identifiers may also be pre-calculated for blocks stored on persistent non-volatile storage, using a database, external file system attributes, or additional files serving as content metadata. When a block with pre-calculated content identifier is read from storage, its content identifier is typically read with it. For example, if the hash value of a storage page is stored and read with the page (possibly from some other location), there is typically no need to calculate hash value again.

Jointly, shards 88 and 89 of all nodes 24 collectively hold the metadata of all the memory pages and cached storage blocks in system 20. Each shard 88 holds the metadata of a subset of the pages, not necessarily the pages stored on the same node. Similarly, each shard 89 holds the metadata of a subset of the cached storage blocks, not necessarily the storage blocks cached on the same node. For a given page of storage block, the shard holding the metadata for the page or block is defined as “owning” the page or block. Any suitable technique can be used for assigning pages and cached storage blocks to shards.

In each node 24, page store 80 communicates with a block stack 76 of the node's Operating System (OS—e.g., Linux) for exchanging storage blocks between volatile memory and non-volatile storage devices. The kernel space of the node also comprises a cluster-wide block driver 78, which communicates with peer block drivers 78 in the other nodes over network 28.

Collectively, drivers 78 implement cluster-wide persistent storage of storage blocks across storage devices 40 of the various nodes. Any suitable distributed storage scheme can be used for this purpose. Cluster-wide block drivers 78 may be implemented, for example, using distributed storage systems such as Ceph, Gluster or Sheepdog, or in any other suitable way. Drivers 78 essentially provide a cluster-wide location-based namespace for storage blocks.

In some embodiments, DPS agents 60 carry out a cache coherence scheme for ensuring cache coherence among the multiple nodes. Any suitable cache coherence scheme, such as MESI or MOESI, can be used.

In different embodiments, the caching mechanism of DPS agents 60 may be implemented as write-back or as write-through caching. Each caching scheme typically involves different fault tolerance means. When implementing write-through caching, for example, the DPS network typically refrains from acknowledging write operations to the UBC driver, until OS block stack 76 acknowledges to the DPS network that the write operation was performed successfully in storage device 40. When implementing write-back caching, fault tolerance is typically handled internally in the DPS network.

In some embodiments, the DPS network caches two or more copies of each cached storage block in different nodes, for fault tolerance. In a typical implementation, two copies are cached in two different nodes, to protect from single-node failure, and higher-degree protection is not required. Alternatively, however, the DPS agents may cache more than two copies of each cached storage blocks, to protect against failure of multiple nodes.

The architecture and functional partitioning shown in FIG. 2 is depicted purely by way of example. In alternative embodiments, the memory sharing scheme can be implemented in the various nodes in any other suitable way.

### Example Message Flows

In a typical flow, when a VM 70 requests hypervisor 68 to read a certain storage block, UBC driver 74 in the hypervisor contacts local DPS agent 60 so as to check whether the requested block is cached in the page store of any of nodes 24. The requested block may be identified to the DPS network by location (e.g., {LUN,LBA} or by content (e.g., GUCID hash value). If the storage block in question is cached by the DPS network, either locally or remotely, the cached block is fetched and served to the requesting VM. If not, the storage block is retrieved from one of storage devices 40 (via OS block stack 76 and cluster-wide block drivers 78).

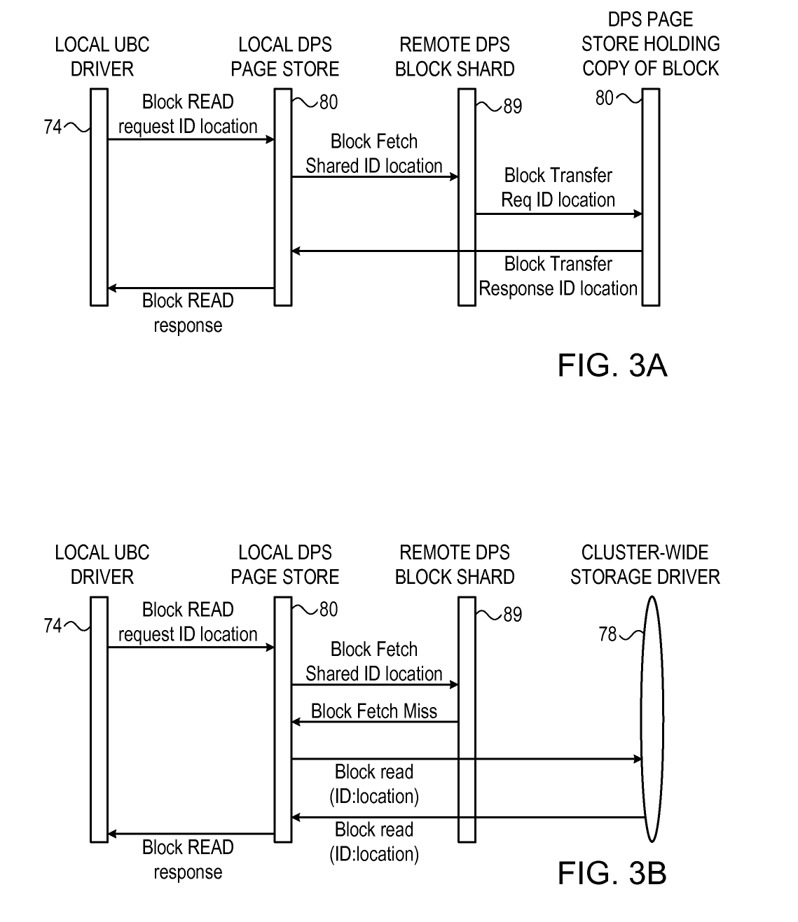

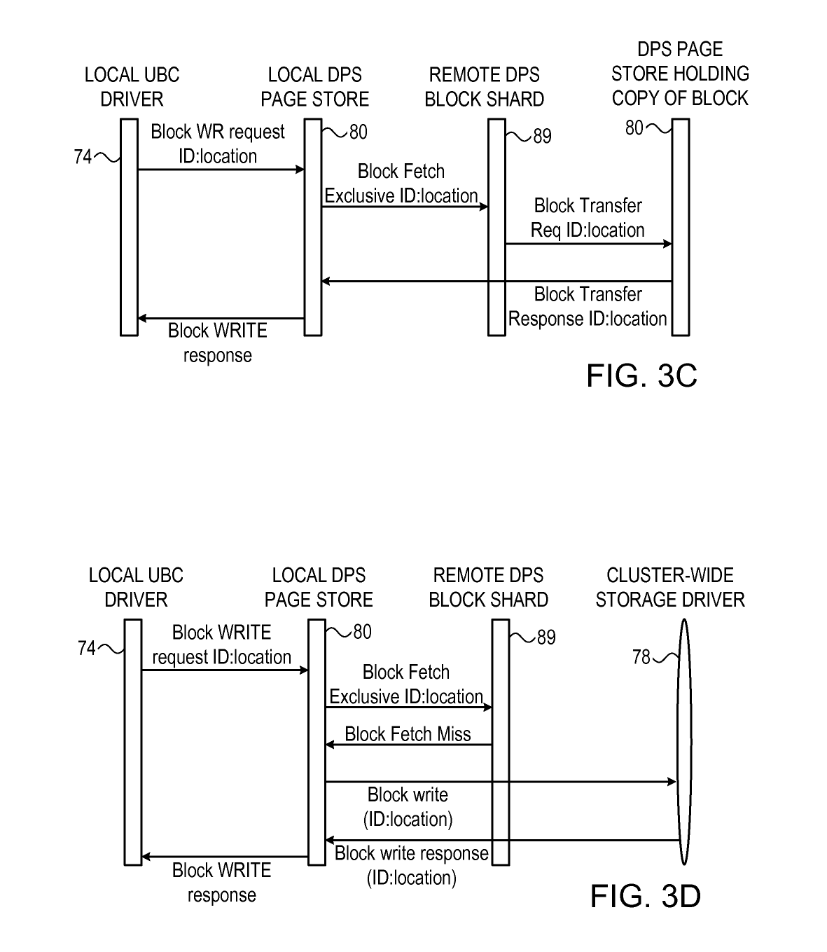

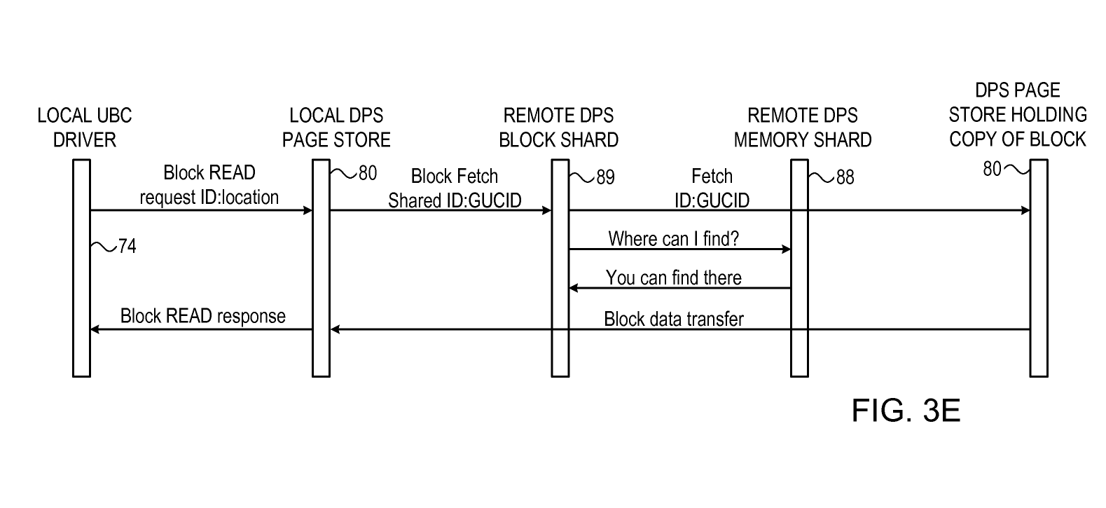

When a VM 70 requests 68 to write a certain storage block, the hypervisor typically updates the DPS network (using UBC driver 74) with the updated block, before writing the block to one of storage devices 40 (via OS block stack 76 and cluster-wide block drivers 78). FIGS. 3A-3E below illustrate these read and write processes.

FIG. 3A is a flow diagram illustrating the message flow of reading a storage block that is cached by the DPS network (“cache hit”), in accordance with an embodiment of the present invention. The process begins with the local UBC driver 74 requesting the local DPS page store 80 for the storage block in question. The requested block is identified by its location in the cluster-wide address space, i.e., by the {LUN,LBA} of the block. This means of identification is used to identify the block throughout the process.

The local DPS page store 80 contacts the block shard 89 of the DPS agent owning the requested block. In the present example this block shard belongs to a remote node, but in some cases the owning block may be the local block shard.

The owning block shard sends a block transfer request to a page store 80 that holds a copy of the requested block. In response to the request, the page store transfers the requested copy to the local page store 80 (the page store on the node that runs the requesting VM). The local page store sends the requested block to the local UBC driver, and hypervisor 68 serves the block to the requesting VM.

FIG. 3B is a flow diagram illustrating the message flow of reading a storage block that is not cached by the DPS network (“cache miss”), in accordance with an embodiment of the present invention. The process begins (similarly to the beginning of the process of FIG. 3A) with the local UBC driver 74 requesting the local DPS page store 80 for the storage block in question. The requested block is identified by location, i.e., by {LUN,LBA}, and this identification is used throughout the process.

The local DPS page store 80 contacts the block shard 89 of the DPS agent owning the requested block. In this scenario, the owning block shard responds with a “block fetch miss” message, indicating that the requested storage block is not cached in the DPS network. In response to this message, the local page store 80 reads the block from its {LUN,LBA} location in the pool of storage devices 40, using cluster-wide storage driver 78. The hypervisor then serves the retrieved storage block to the requesting VM.

FIG. 3C is a flow diagram illustrating the message flow of writing a storage block that is cached by the DPS network (“cache hit”), in accordance with an embodiment of the present invention. The process begins with the local UBC driver 74 requesting the local DPS page store 80 to write the storage block in question. The block is identified by its {LUN,LBA} location, and this means of identification is used to identify the block throughout the process.

If the local DPS page store 80 holds an up-to-date cached copy of the block, and also has exclusive access to the block, then the local DPS page store updates the block locally. Otherwise, the local DPS page store contacts the block shard 89 of the DPS agent owning the requested block, to find whether any other DPS agent holds a cached copy of this block.

In the “cache hit” scenario of FIG. 3C, some remote DPS agent is found to hold a cached copy of the block. The local DPS page store thus fetches a copy of the block with exclusive access, updates the block, and sends an acknowledgement to the VM via the hypervisor.

FIG. 3D is a flow diagram illustrating the message flow of writing a storage block that is not cached by the DPS network (“cache miss”), in accordance with an embodiment of the present invention. The process begins with the local UBC driver 74 requesting the local DPS page store 80 to write the storage block. The block is identified by its {LUN,LBA} location, and this means of identification is used to identify the block throughout the process.

The local DPS page store contacts the block shard 89 of the DPS agent owning the requested block, to find whether any other DPS agent holds a cached copy of this block. In the “cache miss” scenario, no other DPS agent is found to hold a cached copy of the block. The owning block shard 89 thus responds with a “block fetch miss” message.

In response to this message, the local page store 80 writes the block to its {LUN,LBA} location in the pool of storage devices 40, using cluster-wide storage driver 78. The local page store then sends an acknowledgement to the VM via the hypervisor.

FIG. 3E is a flow diagram illustrating the message flow of reading a storage block that is cached by the DPS network (“cache hit”), in accordance with an alternative embodiment of the present invention. In contrast to the previous flows, in the present example the requested storage block is identified by its content rather than by its location. Content-based cache access is demonstrated for the case of readout with cache hit, purely by way of example. Any other scenario (i.e., read or write, with cache hit or miss) can be implemented in a similar manner using content-based rather than location-based identification of storage blocks.

The process of FIG. 3E begins with the local UBC driver 74 requesting the local DPS page store 80 for a storage block requested by a local VM. Between the local UBC driver and the local page store, the storage block is still identified by location (e.g., {LUN,LBA}).

The local page store 80 contacts the block shard 89 owning the storage block, requesting the shard to fetch a copy of the block. From this point onwards, the block is identified by content. In the present example the block is identified by its GUCID, as defined above, e.g., a SHA-1 hash value.

The owning block shard 89 sends a fetch request to a page store 80 that holds a storage block whose content matches the requested GUCID. In response to the request, the page store transfers the matching copy to the local page store 80. The local page store sends the requested block to the local UBC driver, and hypervisor 68 serves the block to the requesting VM.

In parallel, the owning block shard 89 queries memory shard 88 with the requested GUCID, attempting to find a memory page whose content matches the GUCID. If such a memory page is found in the DPS network, the memory shard informs the block shard as to the location of the memory page. The owning block shard may request the memory page from that location, and serve the page back to the local page store.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a plurality of compute nodes that communicate with one another over a communication network, running one or more Virtual Machines (VMs) that access storage blocks stored on non-volatile storage devices coupled to at least some of the compute nodes;
caching one or more of the storage blocks accessed by a given VM, which runs on a first compute node, in a volatile memory of a second compute node that is different from the first compute node; and
serving the cached storage blocks to the given VM.

2. The method according to claim 1, wherein caching the storage blocks comprises caching the storage blocks accessed by the given VM in respective volatile memories of at least two of the compute nodes.

3. The method according to claim 1, wherein the VMs further access memory pages stored in respective volatile memories of the compute nodes, and comprising, upon identifying a cached storage block and a memory page that are stored on the same compute node and hold respective copies of the same content, discarding the cached storage block or the memory page.

4. The method according to claim 1, wherein the VMs further access memory pages stored in respective volatile memories of the compute nodes, and wherein serving the cached storage blocks comprises responding to a request from the given VM for a storage block by retrieving a memory page having identical content to the requested storage block, and serving the retrieved memory page to the VM in place of the requested storage block.

5. The method according to claim 1, wherein caching and serving the storage blocks comprise running on the compute nodes respective memory sharing agents that communicate with one another over the communication network, and caching and serving the storage blocks using the memory sharing agents.

6. The method according to claim 5, and comprising caching a given storage block by defining one of the memory sharing agents as owning the given storage block, and caching the given storage block using the one of the memory sharing agents.

7. The method according to claim 5, wherein serving the cached storage blocks comprises, in response to recognizing that a storage block requested by the given VM is not cached on the first compute node, fetching the requested storage block using the memory sharing agents.

8. The method according to claim 7, wherein fetching the requested storage block comprises sending a query, from a first memory sharing agent of the first compute node to a second memory sharing agent of one of the compute nodes that is defined as owning the requested storage block, for an identity of a third compute node on which the requested storage block is stored, and requesting the storage block from the third compute node.

9. The method according to claim 7, wherein fetching the requested storage block comprises identifying the requested storage block to the memory sharing agents by an identifier indicative of a storage location of the requested storage block in the non-volatile storage devices.

10. The method according to claim 7, wherein fetching the requested storage block comprises identifying the requested storage block to the memory sharing agents by an identifier indicative of a content of the requested storage block.

11. A system comprising a plurality of compute nodes comprising respective volatile memories and respective processors, wherein the processors are configured to run one or more Virtual Machines (VMs) that access storage blocks stored on non-volatile storage devices coupled to at least some of the compute nodes, to cache one or more of the storage blocks accessed by a given VM, which runs on a first compute node, in a volatile memory of a second compute node that is different from the first compute node, and to serve the cached storage blocks to the given VM.

12. The system according to claim 11, wherein the processors are configured to cache the storage blocks accessed by the given VM in respective volatile memories of at least two of the compute nodes.

13. The system according to claim 11, wherein the VMs further access memory pages stored in respective volatile memories of the compute nodes, and wherein, upon identifying a cached storage block and a memory page that are stored on the same compute node and hold respective copies of the same content, the processors are configured to discard the cached storage block or the memory page.

14. The system according to claim 11, wherein the VMs further access memory pages stored in respective volatile memories of the compute nodes, and wherein the processors are configured to respond to a request from the given VM for a storage block by retrieving a memory page having identical content to the requested storage block, and serving the retrieved memory page to the VM in place of the requested storage block.

15. The system according to claim 11, wherein the processors are configured to cache and serve the storage blocks by running respective memory sharing agents that communicate with one another over the communication network, and caching and serving the storage blocks using the memory sharing agents.

16. The system according to claim 15, wherein the processors are configured to cache a given storage block by defining one of the memory sharing agents as owning the given storage block, and caching the given storage block using the one of the memory sharing agents.

17. The system according to claim 15, wherein, in response to recognizing that a storage block requested by the given VM is not cached on the first compute node, the processors are configured to fetch the requested storage block using the memory sharing agents.

18. The system according to claim 17, wherein the processors are configured to fetch the requested storage block by sending a query, from a first memory sharing agent of the first compute node to a second memory sharing agent of one of the compute nodes that is defined as owning the requested storage block, for an identity of a third compute node on which the requested storage block is stored, and requesting the storage block from the third compute node.

19. The system according to claim 17, wherein the processors are configured to identify the requested storage block to the memory sharing agents by an identifier indicative of a storage location of the requested storage block in the non-volatile storage devices.

20. The system according to claim 17, wherein the processors are configured to identify the requested storage block to the memory sharing agents by an identifier indicative of a content of the requested storage block.

21. A compute node, comprising:
a volatile memory; and
a processor, which is configured to run, in conjunction with respective processors of other compute nodes that communicate with one another over a communication network, one or more Virtual Machines (VMs) that access storage blocks stored on non-volatile storage devices coupled to at least some of the compute nodes, to cache one or more of the storage blocks accessed by a given VM, which runs on a first compute node, in a volatile memory of a second compute node that is different from the first compute node, and to serve the cached storage blocks to the given VM.

22. A computer software product, the product comprising a tangible non-transitory computer-readable medium in which program instructions are stored, which instructions, when read by a processor of a compute node that runs, in conjunction with respective processors of other compute nodes that communicate with one another over a communication network, one or more local Virtual Machines (VMs) that access storage blocks stored on non-volatile storage devices coupled to at least some of the compute nodes, cause the processor to cache one or more of the storage blocks accessed by a given VM, which runs on a first compute node, in a volatile memory of a second compute node that is different from the first compute node, and to serve the cached storage blocks to the given VM.
